(19) United States
(12) Patent Application Publication
(10) Pub. No.: US 2011/0293942 A1
(43) Pub. Date: Dec. 1, 2011

(54) VARIABLE TEMPERATURE/CONTINUOUS ION EXCHANGE PROCESS

(76) Inventors: Ivan A Cornejo, Corning, NY (US); Sinue Gomez, Corning, NY (US); Robert A Schaut, Painted Post, NY (US); Steven Alvin Tietje, Lindley, NY (US)

(21) Appl. No.: 13/104,105

(22) Filed: May 10, 2011

Related U.S. Application Data
(60) Provisional application No. 61/348,369, filed on May 26, 2010.

(51) Int. Cl. B32B 33/00; B32B 17/00; C03C 21/00

(52) U.S. Cl. 428/410; 65/30.14; 65/355

(57) ABSTRACT

A method of ion exchanging glass and glass ceramic articles. The method includes immersion of at least one such article in an ion exchange bath having a first end and a second end that are heated to first and second temperatures, respectively. The first and second temperature may either be equal or different from each other, with the latter state creating a temperature gradient across or along the ion exchange bath. Continuous processing of multiple articles is also possible in the ion exchange bath.

### CROSS REFERENCE TO RELATED APPLICATIONS

This application claims the benefit of priority under 35 U.S.C. §119(e) of U.S. Provisional Patent Application No. 61/348,369, filed May 26, 2010, the content of which is relied upon and incorporated herein by reference in its entirety.

### BACKGROUND

The disclosure is related to chemical strengthening of glass and glass ceramic articles. More particularly, the disclosure is related to chemical strengthening of such articles by ion exchange. Even more particularly, the disclosure is related to strengthening such articles in an ion exchange bath having a temperature gradient.

Ion-exchange is one method for strengthening glass and glass ceramic articles. The process involves immersing a glass article in a molten salt bath for a given period of time. While the article is submerged, cationic species interdiffuse between the glass and the salt bath, where larger salt bath cations are exchanged for smaller ions of like valence in the glass. This mismatch in ion size gives rise to a compressive stress at the glass surface and improving glass strength.

The compressive stress generated by ion-exchange has a maximum value at the surface and decreases with depth. In order to maintain force balance, the compressive stresses present at the surface are balanced by tensile stresses or central tension in the center region of the glass. The point at which the stress is zero (or changes sign) is referred to as the depth of layer. For conventional (i.e., processes employing a single temperature, immersion time, substrate thickness, and bath concentration) ion-exchange processes, the relationship between these variables is well-defined. These measures of the ion-exchanged stress field may be related to the mechanical performance of the glass article.

### SUMMARY

A method of ion exchanging glass and glass ceramic articles is provided. The method includes immersion of at least one such article in an ion exchange bath having a first end and a second end that are heated to first and second temperatures, respectively. The first and second temperature may either be equal or different from each other, with the latter state creating a temperature gradient across or along the ion exchange bath. Continuous processing of multiple articles is also possible in the ion exchange bath.

Accordingly, one aspect of the disclosure is to provide a method of ion exchanging a substrate. The method comprises the steps of: immersing a substrate in a first end of an ion exchange bath, the ion exchange bath comprising at least one alkali metal salt and having a first end and a second end, wherein the first end is heated to a first temperature and the second end is heated to a second temperature, and wherein the substrate is one of an ion exchangeable glass and an ion exchangeable glass ceramic and has a strain point; moving the at least one substrate through the ion exchange bath from the first end to the second end, wherein the at least one substrate is ion exchanged while moving through the ion exchange bath; and ion exchanging the at least one substrate at the second end, wherein the ion exchange is sufficient to produce a compressive stress in at least one surface of the substrate.

A second aspect of the disclosure is to provide an ion exchange bath. The ion exchange bath comprises a containment vessel having a first end and a second end opposite the first end and at least one alkali metal salt a molten salt bath disposed in the containment vessel, the molten salt bath comprising at least one alkali metal salt.

A third aspect of the disclosure is to provide a substrate comprising one of an alkali aluminosilicate glass and a glass ceramic. The substrate has at least one surface under compressive stress to a depth of layer, wherein the compressive stress has a maximum value at the surface of the substrate.

These and other aspects, advantages, and salient features will become apparent from the following detailed description, accompanying drawings, and appended claims.

### BRIEF DESCRIPTION OF THE DRAWINGS

FIG. 1 is a schematic representation of an ion exchange bath and a method for ion exchanging a substrate in the ion exchange bath;

FIG. 2 is a plot of relationships between first, second, and third temperatures in an ion exchange bath;

FIG. 3 is a schematic representation of a method for continuously ion exchanging substrates and an ion exchange bath;

FIG. 4 is a schematic cross-sectional view of a planar substrate that has been strengthened by ion exchange; and

FIG. 5 is a plot of hypothetical stress profiles that may be obtained using different ion exchange processes.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range and all ranges therebetween. As used herein, the indefinite articles “a,” “an,” and the corresponding definite article “the” mean “at least one” or “one or more,” unless otherwise specified.

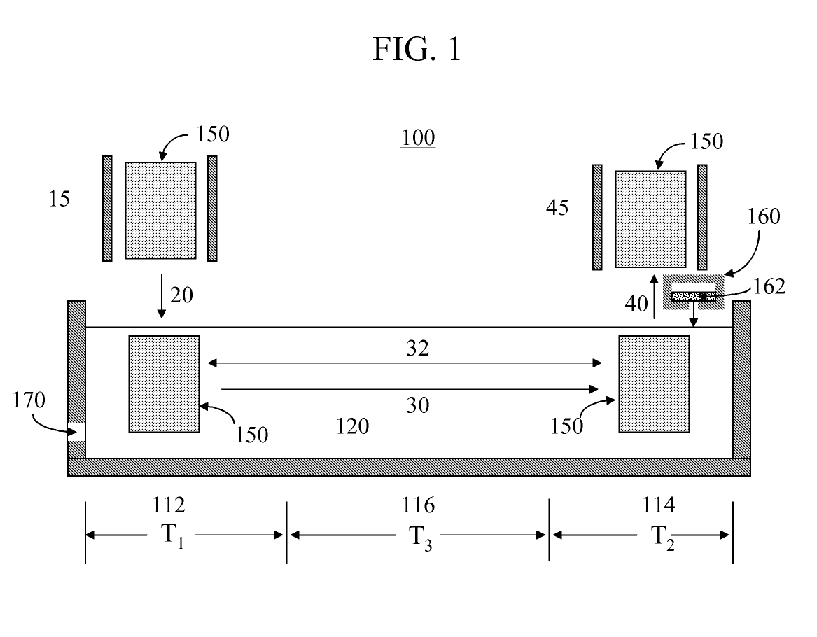

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

Consumer electronic products ranging from laptop computers to cell phones, music and video players, and the like frequently include glass, such as magnesium alkali aluminosilicate glasses, that may be strengthened by ion exchange.

Accordingly, a method of ion exchanging a substrate and chemically strengthening a substrate by ion exchange is provided. In this process, ions in the surface layer of the glass are replaced by—or exchanged with—larger ions having the same valence or oxidation state as the ions present in the glass. Ions in the surface layer of the alkali aluminoborosilicate glass and the larger ions are monovalent metal cations such as, but not limited to, Li⁺, Na⁺, K⁺, Rb⁺, Cs⁺, Ag⁺, Tl⁺, Cu⁺, and the like. The mismatch in ion size generates a compressive stress at the surface, which inhibits both crack formation and propagation. In order for the glass to fracture, the applied stress must first exceed the induced compression and place the surface under sufficient tension to propagate existing flaws.

Ion exchange processes typically comprise immersing a glass or glass ceramic article or substrate (as used herein “article” and “substrate” are equivalent terms and are used interchangeably) in a molten salt bath containing the larger ions to be exchanged with the smaller ions in the glass. It will be appreciated by those skilled in the art that parameters for the ion exchange process including, but not limited to, bath composition and temperature, immersion time, the number of immersions of the glass in a salt bath (or baths), use of multiple salt baths, additional steps such as annealing, washing, and the like, are generally determined by the composition of the glass and the desired depth of layer and compressive stress of the glass or glass ceramic to be achieved by the strengthening process. By way of example, ion exchange of alkali metal-containing glasses may be achieved by immersion in at least one molten salt bath containing a salt such as, but not limited to, nitrates, sulfates, and/or chlorides of the larger alkali metal ion. The temperature of such molten salt baths is typically in a range from about 380° C. up to about 450° C., and immersion times range up to about 16 hours. However, temperatures and immersion times that are different from those described herein may also be used. Such ion exchange treatments typically result in strengthened glasses or glass ceramics having an outer surface layer (also referred to herein a “depth of layer” or “DOL”) that is under compressive stress (CS).

The compressive stress (CS) generated by ion exchange typically has a maximum value at the surface of the article and decreases with depth. In order to maintain force balance within the article, the compressive stresses present at the surface are balanced by tensile stresses, referred to herein as central tension (CT), in the center region of the article. The point at which the total stress is zero or changes sign is referred to as the depth of layer (DOL). For traditional ion-exchange processes that employ a single temperature, time, thickness, and bath concentration, the relationship between these variables is well-defined.

These measures of the ion-exchanged stress field may be related to the mechanical performance of the glass article. For example, retained strength after abrasion or handling improves directly with DOL. Compressive stress is purported to control surface flaw behavior, as determined through ring-on-ring or ball drop testing. Lower central tension is more desirable for controlling breakage during cutting and for frangibility control. As previously stated, CT, CS, and DOL are intimately connected in a single-step ion-exchange process.

In contrast to single step ion exchange, the methods described herein relate to ion-exchange processes in which temperature is a variable rather than a constant. By varying the temperature, CS, DOL, and CT are decoupled from each other, thus enabling specific values to be independently achieved for each parameter. The ability to obtain desired compressive stress, depth of layer, and central tension independently, for example, enables mechanical properties—which are dictated by high CS, high DOL, and low CT—that are desirable for cutting and finishing ion exchanged substrates to be achieved.

Methods of ion exchanging a substrate and chemically strengthening a substrate by ion exchange are schematically represented in FIG. 1. In a first step (step 20 in FIG. 1), the substrate (130 in FIG. 1) is immersed in first end 112 of ion exchange bath 100, where substrate 150 undergoes ion exchange at the temperature of ion exchange bath 100 at first end 112. While FIG. 1 shows only a single substrate 150, it is understood that ion exchange bath 100 may simultaneously accommodate any number of substrates 150 as deemed practical by one skilled in the art. For example, the at least one substrate, in some embodiments, may be placed or loaded into a cassette or holder which enables simultaneous processing of multiple substrates at each step of the method. The time period for ion exchange of substrate 150 at first end 112 of ion exchange bath 100 is selected based upon several factors, including first temperature T₁, the composition of molten salt 120, the composition of the substrate, and the compressive stress profile and depth of compressive layer that are ultimately desired.

In some embodiments, the method includes first providing at least one substrate (Step 10). The at least one substrate is an ion exchangeable glass or glass ceramic and, in various embodiments, comprises, consists essentially of, or consists of an alkali aluminosilicate glass or a glass ceramic such as an alkali aluminosilicate glass ceramic. Such glasses and glass ceramics are described herein below. In those embodiments where the substrate is an alkali aluminosilicate glass, the step of providing the substrate may include down-drawing the substrate, using those methods known in the art such as, but not limited to, fusion-drawing, slot-drawing, re-drawing, and the like. In some embodiments, the substrate has a planar configuration, such as, for example, a sheet. Alternatively, the substrate may have a non-planar or three dimensional configuration, and may form curved or partially curved surfaces.

In some embodiments, an ion exchange bath is also provided (Step 20). The ion exchange bath is typically a molten (i.e., liquid) or partially molten salt bath. In some embodiments, the ion exchange bath comprises, consists essentially of, or consists of at least one alkali metal salt such as, but not limited to, nitrates, sulfates, and halides of sodium and potassium or other alkali metals. In some embodiments, the ion exchange bath may also include salts of other monovalent metals (e.g., Ag⁺, Tl⁺, Cu⁺, or the like). In some embodiments, the ion exchange bath is a eutectic mixture of such salts or a molten solution of one salt in a second salt. One non-limiting example of a molten salt solution is a solution of potassium nitrate in ammonium nitrate

One embodiment of the ion exchange bath described herein is schematically shown in FIG. 1. Ion exchange bath 100 has a first end 112 and a second end 114 opposite the first end 112, and comprises molten salt 120 disposed in a containment vessel 110. First end 112 is heated to a first temperature T₁ and second end 114 is heated to a second temperature T₂. In some embodiments, at least one portion 116 or region of the ion exchange bath 100 between first end 112 and second end 114 may be heated to a third temperature T₃. Whereas FIG. 1 shows only one such portion 116 heated to a third temperature T₃, in some embodiments, multiple sections located between first end 112 and second end 114 may each be heated to a selected temperature. Unless otherwise specified, all temperatures described herein (e.g., first temperature T₁, second temperature T₂, and third temperature T₃) are sufficient to at least partially liquefy—and, preferably, completely liquefy—the salts in ion exchange bath 100. In some embodiments, at least one of first temperature T₁, second temperature T₂, and third temperature T₃ is at least 100° C. less than the strain point of the substrate. As used herein, the term “heated to a temperature” means that ion exchange bath 100 is heated to the stated temperature in the specified location (e.g., first end 112, second end 114, etc.) of ion exchange bath. Ion exchange bath 100, in some embodiments, is externally heated by resistance heaters (not shown) or other such means known in the art by placing such heaters outside containment vessel 110. Alternatively, ion exchange bath may be heated internally by inserting heating elements (not shown) directly in molten salt 120 of ion exchange bath 100, or by placing such elements within protective sleeves, which are then inserted in molten salt 120.

In some embodiments, substrate 150 is preheated (step 15) prior to immersion in ion exchange bath 100 to avoid cracking or breakage due to thermal shock upon immersion in the molten salt 120. Preheating of substrate 150 may take place in a separate furnace and, in some embodiments, includes preheating substrate to a temperature that is greater than or equal to first temperature T₁.

Following immersion and ion exchange in first end 112 of ion exchange bath, substrate 150 is moved or translated (step 30) through molten salt 120 and ion exchange bath 100 to second end 114 along a path 32. Such movement or translation of substrate 150 may be achieved by those means that are known in the art, such as by chain or belt drives that are coupled to substrate 150, manual movement or placement, or the like. Such movement of substrate 150 may either be continuous or take place in discrete intervals or steps. Similarly, substrate 150 may be positioned or held at second end 114 for any desired length or time.

Ion exchange of substrate 150 continues while substrate 150 is moved from first end 112 to second end 114 of ion exchange bath. Ion exchange is allowed to continue for a time period that is sufficient to achieve a selected compressive stress profile and depth of compressive layer. As previously described hereinabove, time periods for ion exchange are based upon several factors, including first temperature T₁ and second temperature T₂, the composition of molten salt 120, and the composition of substrate 150. In one embodiment, substrate 150 is ion exchanged for a period of time and under conditions that are sufficient to produce a maximum compressive stress at the surface of the substrate 150. In another embodiment, at least one of a desired compressive stress, central tension, and/or depth of layer is selected, and substrate 150 is ion exchanged a time period that is sufficient to achieve these parameters.

Following ion exchange to the desired level, substrate 150 is removed from ion exchange bath 110 (step 40). In some embodiments, substrate 150 is rapidly cooled and/or rinsed with deionized water (step 45).

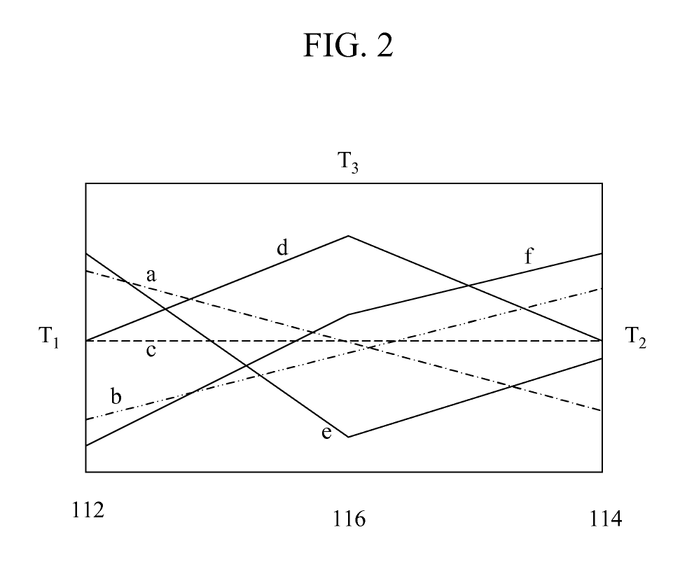

Possible relationships between first temperature T₁ and second temperature T₂ are schematically shown in FIG. 2. In some embodiments, temperatures T₁ and T₂ of first end 112 and second end 114, respectively, are different from each other. This difference in temperature gives rise to a temperature gradient from first end 112 to second end 114 within molten salt 120 and ion exchange bath 100. In at least one embodiment, first temperature T₁ differs from second temperature T₂ by at least 10° C. (i.e., T₁+10° C.≦T₂; or T₁≧T₂+10° C.). Alternatively, first temperature T₁ and second temperature T₂ may be equal (T₁=T₂; c in FIG. 2). Whether first temperature T₁ is less than (T₁<T₂; b in FIG. 2) or greater than (T₁>T₂; a in FIG. 2) second temperature T₂ depends in part upon the composition of the molten salt bath 120 and the desired compressive stress, depth of layer, and/or composition profile of the surface compressive layer of the substrate 150.

In some embodiments, a portion 116 of the ion exchange bath 100 separating first end 112 from second end 114 is heated to a third temperature T₃ that is different from both first temperature T₁ and second temperature T₂. Third temperature T₃ may be either less than (T₃<T₁, T₂; e in FIG. 2) or greater than (T₃>T₁, T₂; d in FIG. 2) both T₁ and T₂. Alternatively, T₃ may be greater than one of T₁ and T₂; i.e., T₃ may be between T₁ and T₂ (T₂>T₃>T₁; e in FIG. 2, or T₂<T₃<T₁). While FIG. 2 shows sharp, linear variations in temperature with position in ion exchange bath 100, the actual temperature of molten salt 120 may vary in a more continuous manner, due to the fact that portions of molten salt 120 in first end 112 and second end 140 are in fluid communication with each other.

The rate at which the ions exchange is related to the interdiffusivity of the ions that undergo exchange. The exchange rate and interdiffusivity follow an Arrhenius relationship and thus vary by many orders of magnitude with temperature. Because diffusivity increases with temperature, similar composition profiles may be produced with different combinations of temperature and immersion/ion exchange time (e.g., ion exchange at higher temperature for a shorter time may produce the same profile as ion exchange at lower temperature for a longer time). However, increasing temperature has its consequences, as the compressive stress profile generated by ion exchange also strongly depends upon temperature. Whereas higher temperatures allow for ions to diffuse more rapidly, they also promote stress-relaxation, limiting the maximum compressive stress achievable at the surface.

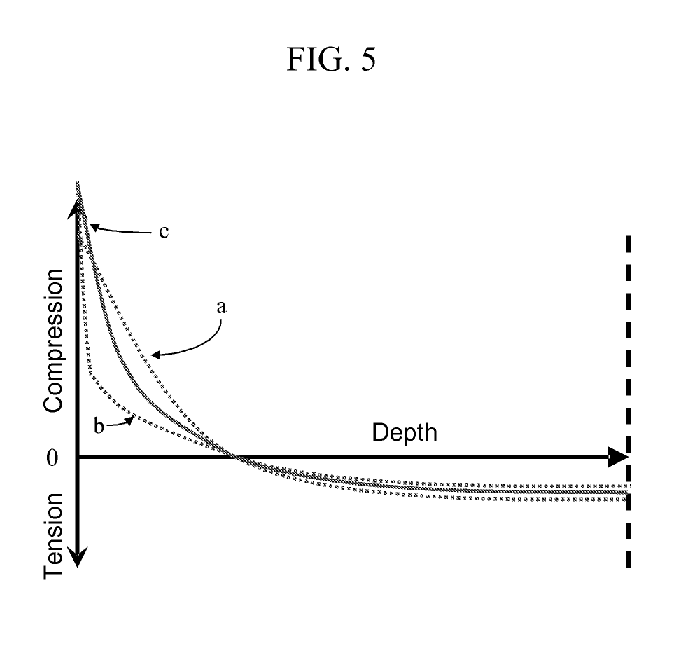

By heating first end 112 to first temperature T₁ and heating second end 114 to second temperature T₂, high and low temperature ion exchange processes are combined in a single ion exchange bath 100 to produce a stress profile having specific compressive stress, central tension, and depth of layer. FIG. 5 is a plot of hypothetical stress profiles that may be obtained using: a) immersion for a set time in a single ion exchange bath at a single temperature (a in FIG. 5); b) immersion in a first ion exchange bath at a first temperature followed by immersion in a second, separate ion exchange bath at a different temperature (b in FIG. 5); and c) immersion in ion exchange bath 100, described herein, in which the temperature is varied from first end 112 to second end 114, creating a temperature gradient between first end 112 to second end (c in FIG. 5). The ion exchange bath 100 and method described herein requires less process time than immersion in a single ion exchange bath or successive immersion in two separate baths to produce a substrate 150 having lower central tension and a compressive stress and depth of layer that are similar.

As seen in FIG. 1, ion exchange bath 100 is a continuous, single bath. In those embodiments where T₁ and T₂ (and, in some embodiments, T₃) are different from each other, such differences create a continuous temperature gradient within ion exchange bath 100 as shown in FIG. 2. The temperature gradient gives rise to differences in density and concentrations in molten salt 120, and convective movement, transport, and/or flow of molten salt 120 occurs between first end 112 and second end 114. In some embodiments, such convective flow may be reduced by the placement of baffles, gates, or other means of limiting convective flow and/or turbulent motion of molten salt 120 in ion exchange bath 100. Alternatively, turbulent flow or flow perturbation in ion exchange bath 100 may be increased by either internal or external means by providing sound energy, electric fields, bubblers, stirrers, screws, or the like for agitating fluid that are known in the art.

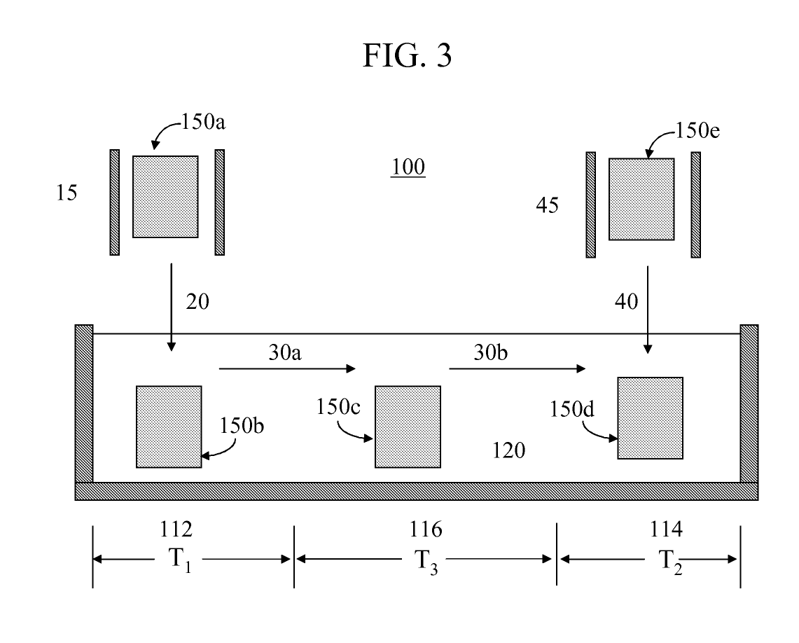

In some embodiments, first temperature T₁ and second temperature T₂ are equal and ion exchange bath 100 has an essentially flat, isothermal temperature profile (c in FIG. 2). In this instance, the methods of ion exchanging substrates described herein is a continuous process rather than a batch process, as ion exchange bath 100 may be used to process multiple substrates (150a-e in FIG. 3) in succession, as schematically shown in FIG. 3. As seen in FIG. 3, substrates 150b, 150c, and 150d are undergoing ion exchange in first end 112, portion 116 separating first end 112 and second end 114, and second end 114, respectively. At the same time, substrate 150a is preheated (step 15) and substrate 150d is fast cooled (step 45). As one substrate 150 is moved or translated from one step or location in ion exchange bath to the next step or location (e.g., substrate 150b moves from first end 112 to portion 116 in step 30a), another substrate 150 takes the place of the previous substrate 150 (e.g., substrate 150a moves is immersed in first end 112 in step 20).

During the ion exchange process, effluent ions removed from the glass may serve as a source of contamination, thus slowing down the ion exchange process. For example, sodium ions removed from the glass act as contaminants in an ion exchange bath comprising a potassium salt. Currently, such contamination is addressed by discharging the contaminated salt from the ion exchange bath, loading the bath with “fresh” or pure salt, and melting the salt. To reduce the effect of such contamination, ion exchange bath 100 described herein may also be provided with means to selectively deplete or enrich molten salt 120 with at least one material or component. Such enrichment and/or depletion may be provided at different locations in ion exchange bath 100; e.g., at first end 112 or second end 114. Molten salt 120 may be removed, for example, through a drain 170 (FIG. 1). Alternatively, additional at least one salt 162 may be added to ion exchange bath by providing a source or reservoir 160. As shown in FIG. 1, reservoir 160 is positioned with respect to ion exchange bath 100 so as to deliver the at least one salt 162 directly to second end 114 of ion exchange bath 100. In another embodiment (not shown), reservoir 160 is coupled to ion exchange bath 100 such that a chamber containing the at least one salt 162 is in fluid communication with molten salt 120.

While drain 170 and reservoir 160 are located at first end 112 and second end 114, respectively, in FIG. 1, it will be appreciated by those skilled in the art that drain 170 and reservoir 160 may be located anywhere in ion exchange bath 100. Drain 170 may, for example, be located in a region of ion exchange bath 100 that, due to chemical balance of the ion exchange process or equilibrium considerations, is enriched with a particular cation (e.g., Na⁺ or K⁺). A greater proportion of the enriched cation would thus be removed through drain 170, and chemical balance of molten salt 120 may at least be partially restored. Similarly, the at least one salt 162 may be added to molten salt 120 from reservoir 160 to restore or maintain chemical balance in ion exchange bath 100. Alternatively, the at least one salt 162 may be added to molten salt 120 from reservoir 160 in a region in which enrichment of molten salt bath 120 with a cation is particularly desired.

A chemically strengthened substrate is also provided. The substrate is an ion exchangeable glass or glass ceramic and, in various embodiments, comprises, consists essentially of, or consists of an alkali aluminosilicate glass or a glass ceramic such as, for example, an alkali aluminosilicate glass ceramic. In some embodiments, the substrate has a planar configuration, such as, for example, a sheet. Alternatively, the substrate may have a non-planar or three dimensional configurations, and may form curved or partially curved surfaces.

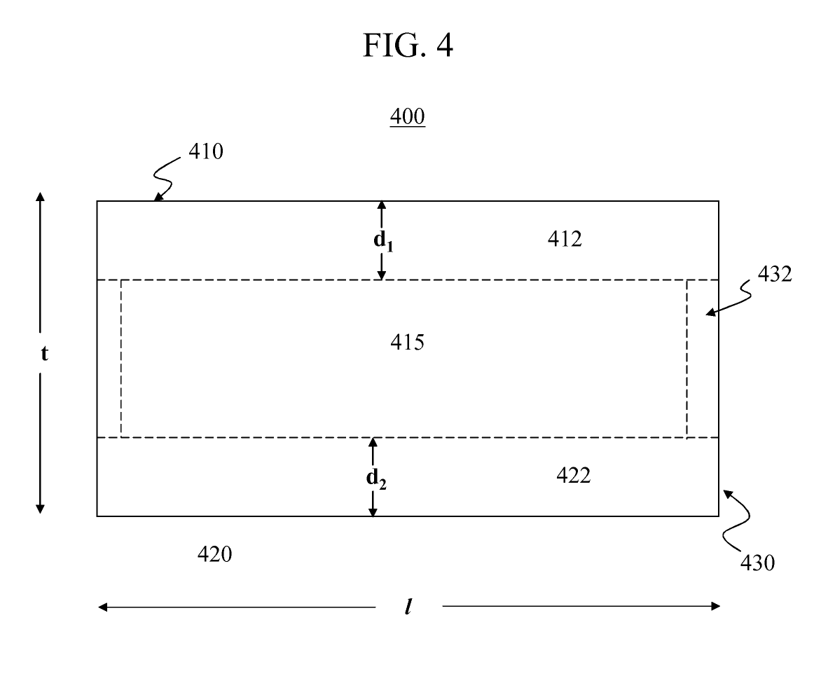

A cross-sectional view of a planar glass or glass ceramic substrate strengthened by ion exchange is schematically shown in FIG. 4. Strengthened substrate 400 has a thickness t, a first surface 410 and second surface 420 that are substantially parallel to each other, central portion 415, and edges 430 joining first surface 410 to second surface 420. Strengthened substrate 400 has strengthened surface layers 412, 422 extending from first surface 410 and second surface 420, respectively, to depths d₁, d₂, below each surface. Strengthened surface layers 412, 422 are under a compressive stress, while central portion 415 is under a tensile stress, or in tension. The tensile stress in central portion 415 balances the compressive stresses in strengthened surface layers 412, 422, thus maintaining equilibrium within strengthened substrate 400. The depths d₁, d₂ to which the strengthened surface layers 412, 422 extend are generally referred to individually as the “depth of layer.” A portion 432 of edge 430 may also be strengthened as a result of the strengthening process. Thickness t of strengthened glass substrate 400 is generally in a range from about 0.1 mm up to about 2 mm. In one embodiment, thickness t is in a range from about 0.5 mm up to about 1.3 mm.

In some embodiments, the substrate is an alkali aluminosilicate glass substrate comprising, consisting essentially of, or consisting of: 60-72 mol % SiO₂; 9-16 mol % Al₂O₃; 5-12 mol % B₂O₃; 8-16 mol % Na₂O; and 0-4 mol % K₂O, wherein the ratio

$$\frac{{Al}_{2} {O}_{3} ( mol \% ) + {B}_{2} {O}_{3} ( mol \% )}{\sum alkali metal modifiers ( mol \% )} > 1 ,$$

where the alkali metal modifiers are alkali metal oxides. In another embodiment, the alkali aluminosilicate glass substrate comprises, consists essentially of, or consists of: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO. In yet another embodiment, the alkali aluminosilicate glass substrate comprises, consists essentially of, or consists of: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %. In another embodiment, the alkali aluminosilicate glass substrate comprises, consists essentially of, or consists of: 64-68 mol % SiO₂; 12-16 mol % Na₂O; 8-12 mol % Al₂O₃; 0-3 mol % B₂O₃; 2-5 mol % K₂O; 4-6 mol % MgO; and 0-5 mol % CaO, wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)−Al₂O₃≦2 mol %; 2 mol %≦Na₂O−Al₂O₃≦6 mol %; and 4 mol %≦(Na₂O+K₂O)−Al₂O₃≦10 mol %. In yet another embodiment, the alkali aluminosilicate glass comprises, consists essentially of, or consists of: 50-80 wt % SiO₂; 2-20 wt % Al₂O₃; 0-15 wt % B₂O₃; 1-20 wt % Na₂O; 0-10 wt % Li₂O; 0-10 wt % K₂O; and 0-5 wt % (MgO+CaO+SrO+BaO); 0-3 wt % (SrO+BaO); and 0-5 wt % (ZrO₂+TiO₂), wherein 0≦(Li₂O+K₂O)/Na₂O≦0.5.

The alkali aluminosilicate glass substrate is, in some embodiments, substantially free of lithium, whereas in other embodiments, the alkali aluminosilicate glass is substantially free of at least one of arsenic, antimony, and barium. In some embodiments, the glass substrate is down-drawn, using those methods known in the art such as, but not limited to fusion-drawing, slot-drawing, re-drawing, and the like, and has a liquid viscosity of at least 135 kpoise.

The alkali aluminosilicate glass substrate is strengthened by ion exchange using those methods described hereinabove and has at least one surface under compressive stress, wherein the compressive stress has a maximum value at the surface. In one embodiment, the compressive stress is at least 600 Mpa. The compressive stress layer extends from the surface to a depth of at least 20 μm and, in some embodiments, at least 30 μm.

In other embodiments, the chemically strengthened substrate is a glass ceramic, such as an alkali aluminosilicate glass ceramic. Such glass ceramics include, but are not limited to, nepheline, β-quartz (e.g., Keralite™), β-spodumene, sodium micas, lithium disilicates, combinations thereof, and the like.

The glass ceramic substrate is strengthened by ion exchange using those methods described hereinabove and has at least one surface under compressive stress, wherein the compressive stress has a maximum value at the surface. In one embodiment, the compressive stress is at least 400 MPa. The compressive stress layer extends from the surface to a depth of at least 20 μm and, in some embodiments, at least 30 μm.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. A method of ion exchanging a substrate, the method comprising the steps of:
a. immersing a substrate in a first end of an ion exchange bath, the ion exchange bath comprising at least one alkali metal salt and having a first end and a second end, wherein the first end is heated to a first temperature and the second end is heated to a second temperature, and wherein the substrate is one of an ion exchangeable glass and an ion exchangeable glass ceramic and has a strain point;
b. translating the at least one substrate through the ion exchange bath from the first end to the second end, wherein the at least one substrate is ion exchanged while moving through the ion exchange bath; and
c. ion exchanging the at least one substrate at the second end, wherein the ion exchange is sufficient to produce a compressive stress in at least one surface of the substrate.

2. The method of claim 1, wherein the first temperature is different from the second temperature, and wherein a temperature gradient exists between the first end and the second end.

3. The method of claim 1, wherein a portion of the ion exchange bath located between the first end and the second end is heated to a third temperature that is different from the first temperature and the second temperature, and wherein the step of moving the substrate from the first end to the second end comprises moving the substrate through the portion that is heated to the third temperature.

4. The method of claim 1, wherein at least one of the first temperature and the second temperature is at least 100° C. less than the strain point of the substrate.

5. The method of claim 1, wherein the ion exchangeable glass is an alkali aluminosilicate glass.

6. The method of claim 1, wherein the ion exchangeable glass is free of lithium.

7. The method of claim 1, wherein the ion exchangeable glass ceramic is one of nepheline, β-quartz, β-spodumene, sodium micas, lithium disilicates, and combinations thereof.

8. The method of claim 1, further comprising providing successively providing a first substrate and a second substrate, wherein:
a. the step of immersing the at least one substrate in the first end comprises immersing the first substrate and the second substrate in the first end in succession; and
b. the step of moving the at least one substrate through the ion exchange bath from the first end to the second end comprises successively moving the first substrate and second substrate to the second end in succession.

9. The method of claim 1, further comprising removing one of the at least one alkali salt from the ion exchange bath.

10. The method of claim 1, further comprising adding an alkali metal salt to the ion exchange bath.

11. An ion exchange bath, the ion exchange bath comprising:
a. a containment vessel having a first end and a second end opposite the first end; and
b. a molten salt bath disposed in the containment vessel, the molten salt bath comprising at least one alkali metal salt, wherein the first end is heated to a first temperature and the second end is heated to a second temperature.

12. The ion exchange bath of claim 11, wherein the first temperature is different from the second temperature, and wherein a temperature gradient exists between the first end and the second end.

13. The ion exchange bath of claim 11, wherein the ion exchange bath comprises a third portion located between the first end and the second end, wherein the third portion is heated to a third temperature that is different from the first temperature and the second temperature.

14. The ion exchange bath of claim 11, further comprising a sample movement mechanism for moving at least one sample from the first end to the second end through the molten salt bath.

15. The ion exchange bath of claim 11, further comprising a means for removing at least one alkali metal salt from the ion exchange bath.

16. The ion exchange bath of claim 11, further comprising a means for adding at least one alkali metal salt from the ion exchange bath.

17. A substrate comprising one of an alkali aluminosilicate glass and a glass ceramic, the substrate having at least one surface under compressive stress to a depth of layer, wherein the compressive stress has a maximum value at the surface of the substrate.

18. The substrate of claim 17, wherein the substrate comprises an alkali aluminosilicate glass, and wherein the maximum value of the compressive stress is at least 600 MPa, and wherein the depth of layer is at least 20 μm.

19. The substrate of claim 17, wherein the alkali aluminosilicate glass is free of lithium.

20. The substrate of claim 17, wherein the alkali aluminosilicate glass has a liquidus viscosity of at least 135 kpoise.

21. The substrate of claim 17, wherein the substrate comprises a glass ceramic, and wherein the glass is one of nepheline, β-quartz, β-spodumene, sodium micas, lithium disilicates, and combinations thereof, and wherein the glass ceramic has a maximum compressive stress of at least 400 MPa.
